(19) United States
(12) Patent Application Publication
(10) Pub. No.: US 2007/0237931 A1
(43) Pub. Date: Oct. 11, 2007

(54) Surface structure for sports protector

(75) Inventor: Ching Piao Hsu, Hsin Tien City (TW)

Correspondence Address: TROXELL LAW OFFICE PLLC;SUITE 1404, 5205 LEESBURG PIKE, FALLS CHURCH, VA, 22041, US

(73) Assignee: Long Way Enterprise Co., Ltd.

(21) Appl. No.: 11/391,618

(22) Filed: Mar. 29, 2006

(51) Int. Cl. B32B 3/00

(52) U.S. Cl. 428/204

(57) ABSTRACT

A surface structure for sports protector includes a main body for a sports protector, a CPP film connected to an outer surface of the main body, and a pattern layer located between the CPP film and the main body. The CPP film and the pattern layer are connected to the main body by cutting the CPP film to dimensions corresponding to the main body, applying the pattern layer to an inner side of the CPP film, positioning the CPP film having the pattern layer applied thereto in an injection mould, injecting a plastic material into the mould, and allowing the injected plastic material to cool and mold, so as to form the main body of the sports protector with the CPP film bonded to the molded main body and the pattern layer enclosed between the CPP film and the main body without the risk of being rubbed away.

### FIELD OF THE INVENTION

The present invention relates to a surface structure for sports protector, and more particularly to a sports protector having a casting polypropylene (CPP) film and a pattern layer bonded to an outer surface thereof to thereby become wear-resisting, distinguishable, and easy to produce.

### BACKGROUND OF THE INVENTION

In recent years, people pay more and more attention to their health condition. A large part of people would play different ball games, such as basketball, football, and the like, or take different exercises in holidays as a way to improve the health condition. Therefore, it is a very important issue to prevent athletic injury that inevitably occurs during sports, games, and exercises to adversely affect the daily life of the injured people. In addition to proper warm-up and correct movements, a sports protector worn at suitable body area is a good means of protection in sports and exercises.

A sports protector is designed to prevent athletic injury or protect an injured body area. The sports protector is able to limit the joint mobility, reduce skin friction, or absorb impact energy to achieve the purpose of protection.

A conventional sports protector mainly includes a surface shell layer, an elastic buffering layer, and a foamed material layer. After these layers are press molded and laminated, Velcro® tapes (loop and hook tapes) and retaining rings are then firmly sewed thereto. The elastic buffering layer is made of a soft elastic material, which is molded by way of hot pressing or foaming to have a configuration matching the curve of a desired body area. The surface shell layer, the buffering layer, and the foamed layer are further processed along a periphery thereof to form an integral body.

The conventional sports protector is manufactured through the steps of forming a plastic shell by injection molding a plastic material, cleaning the injected plastic shell to remove dust and grease therefrom, mounting the plastic shell on a fixture, using static electricity to further remove dust from the plastic shell, priming the plastic shell with suitable chemical agents to ensure good reaction of an electroplating solution with the surface of the plastic shell in the subsequent steps, baking the treated plastic shell at a temperature from 60to 65° C. for 2.5 to 3 hours, subjecting the baked plastic shell to vacuum plating, spraying a surface paint over the vacuum plated plastic shell, and baking the plastic shell for another 10 to 15 minutes to complete the plastic shell for the sports protector.

In the above-mentioned process for forming the conventional plastic shell for sports protector, patterns or designs are applied to the surface of the plastic shell by spraying paint or electroplating. These two types of finishing processes are extremely time-consuming and subject to high bad yield. In the case of spraying paint, the obtained patterns or designs are dull and monotonous in color, and the transparent surface paint tends to be worn away and peel off over a period of time, so that the patterns or designs behind the paint are gradually exposed to the air and become vague to give the plastic shell a dull and old appearance. In the case of vacuum plating, a brilliant and eye-catching visual effect may be obtained for the plastic shell. However, the electroplating equipment is expensive to increase the manufacturing cost of the sports protector, and the electroplating is not suitable for forming a plated layer on the surface of a plastic shell with a certain degree of flexibility. Moreover, both of the two finishing processes are harmful to workers and environment. Therefore, it is necessary to improve the conventional plastic shell for sports protector from the manufacturing process thereof.

### SUMMARY OF THE INVENTION

A primary object of the present invention is to provide a surface structure for sports protector, in which a CPP film is bonded to an outer surface of a main body of a sports protector, so as to protect a pattern layer located between the main body and the CPP film.

Another object of the present invention is to provide a surface structure for sports protector, in which a CPP film showing a design is positioned in an injection mould before a plastic material is injected into the mould to mold the sports protector, so that the molded sports protector presents a good visual effect on its surface.

A further object of the present invention is to provide a surface structure for sports protector, in which a CPP film showing a design is directly bonded to the sports protector to reduce possible harms to workers and environment in the manufacturing process of the sports protector.

A still further object of the present invention is to provide a surface structure for sports protector, in which a CPP film showing a design is directly bonded to the sports protector to increase the productivity and good yield of the sports protector.

To achieve the above and other objects, the surface structure for sports protector according to the present invention is formed by cutting a CPP film to dimensions corresponding to a main body of the sports protector to be produced, applying a pattern layer to an inner side of the CPP film, positioning the CPP film having the pattern layer applied thereto in an injection mould, injecting a high temperature plastic material into the mould by way of direct injecting technology (DIT), and allowing the injected plastic material to cool and mold, so as to form the main body of the sports protector with the CPP film bonded to the molded main body and the pattern layer enclosed between the CPP film and the main body without the risk of being rubbed away.

In the present invention, the CPP film has a thickness within the range from 0.3 mm to 1.0 mm.

In an embodiment of the present invention, the pattern layer includes a design showing an electroplating effect or a continuous laser coating effect.

In an operable embodiment of the present invention, the pattern layer is applied to the CPP film by way of painting.

In a preferred embodiment of the present invention, the pattern layer is applied to the CPP film by way of printing.

When the CPP film having the pattern layer applied thereto is bonded to the main body of the sports protector, a protective layer with brilliant design showing an electroplating or continuous laser coating effect is formed on the surface of the sports protector.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary sectional view schematically showing the surface structure for sports protector according to the present invention;

FIG. 2 is an exploded view of FIG. 1 showing the forming of the surface structure for sports protector according to the present invention; and

FIG. 3 is a flowchart showing the steps of forming the surface structure for sports protector according to the present invention.

### DETAILED DESCRIPTION OF THE PREFERRED EMBODIMENTS

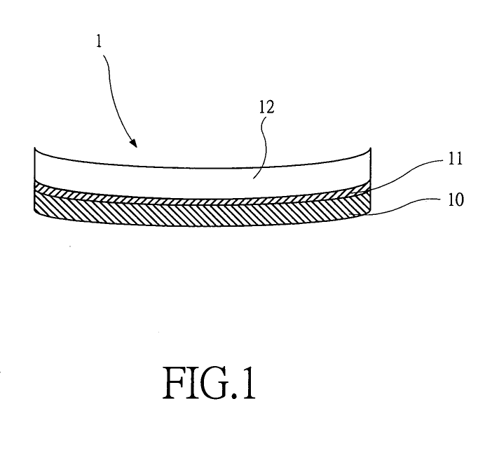

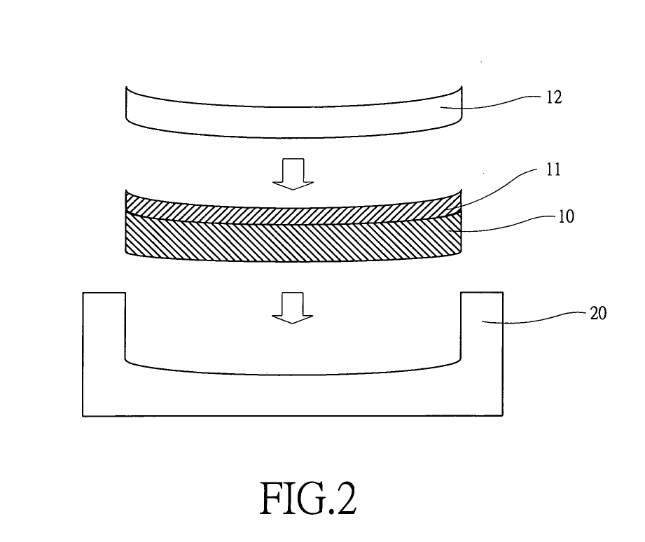

Please refer to FIGS. 1 and 2 that are assembled and exploded sectional views, respectively, showing a surface structure for sports protector according to a preferred embodiment of the present invention.

A sports protector 1 includes a main body 12, a non-directional casting polypropylene (CPP) film 10 connected to an outer surface of the main body 12, and a pattern layer 11 located between the CPP film 10 and the outer surface of the main body 12.

The sports protector with the surface structure of the present invention is manufactured in the following steps:
a. Cutting a piece of CPP film 10 having dimensions corresponding to a surface area of the sports protector 1;
b. Applying a pattern layer 11 to an inner side of the CPP film 10;
c. Positioning the CPP film 10 with the pattern layer 11 applied thereto in an injection mould 20;
d. Injecting a plastic material into the injection mould 20; and
e. Obtaining a finished product of the sports protector 1.

Wherein, the CPP film 10 has a thickness within the range from 0.3 mm to 1.0 mm.

In an embodiment of the present invention, the pattern layer 11 includes a design showing an electroplating effect or a continuous laser coating effect.

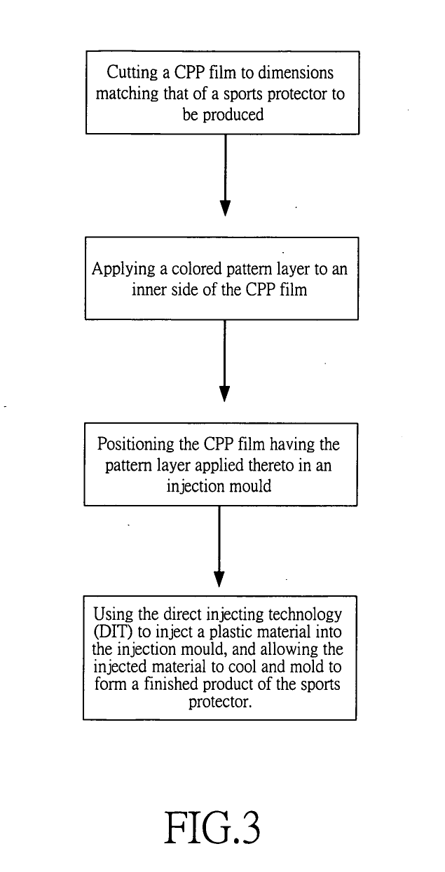

FIG. 3 is a flowchart showing more detailed steps of producing a sports protector 1 with the surface structure of the present invention. First, a finished CPP film 10 is cut to dimensions matching that of an outer surface of the sports protector 1 to be produced, and then print the pattern layer 11 showing the electroplating or continuous laser coating effect on an inner side of the CPP film 10. The pattern layer 11 may also be any other color and design that could be printed on the CPP film 10.

In an operable embodiment of the present invention, the pattern layer 11 is provided on the CPP film 10 by way of painting.

In a preferred embodiment of the present invention, the pattern layer 11 is provided on the CPP film 10 by way of printing.

The CPP film 10 with the pattern layer 11 applied thereto is then fixedly positioned at an innermost layer in the injection mould 20 without the risk of moving therein during the injecting process. The plastic material is injected into the injection mould 20 by way of direct injecting technology (DIT), so that the main body 12 of the sports protector 1 is molded on a top of the pattern layer 11 in the injection mould 20. The main body 12 and the CPP film 10 with the pattern layer 11 are caused to mutually bond to each other under a high temperature of the injected plastic material. The CPP film 10 has a natural material property that enables the CPP film 10 to firmly attach to the main body 12. When the main body 12 of the sports protector 1 is cooled and molded, the molded sports protector 1 is removed from the injection mould 20 to provide a finished product of sports protector having the surface structure according to the present invention.

In the present invention, the injection mould 20 adopted to mold the sports protector 1 is preferably an upright injection molding machine allowing back feeding of plastic injecting material. In the case of a mould with a relatively large curvature, a static eliminator must be used to enable the CPP film 10 to fully attach to the surface of the injecting mould 20.

The manufacturing process shown in FIG. 3 simplifies and improves the prior complicate process of coloring the sports protector, so that the sports protector 1 could be manufactured at reduced bad yield, increased productivity, and upgraded quality. The CPP film 10 has good wear-resisting property to provide a protection effect, so that the sports protector 1 in use is protected by the CPP film 10 against rubbing to damage the pattern layer 11. Moreover, the pattern layer 11 printed on the CPP film 10 presents a design with laser effect to thereby create an eye-catching visual effect on the surface of the sports protector 1.

With the surface structure for sports protector according to the present invention, a sports protector 1 creating an eye-catching visual effect can be more efficiently produced at increased good yield and reduced cost. The environmental pollution possibly caused by electroplating in the conventional process for manufacturing the sports protector 1 may also be avoided. In brief, the sports protector 1 with the surface structure according to the present invention is wearing-resistant, distinguishable, and easy to produce.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A surface structure for sports protector, comprising a main body for the sports protector, a CPP film connected to an outer surface of said main body, and a pattern layer located between said CPP film and the outer surface of said main body; wherein said CPP film and said pattern layer are connected to said main body through the steps of cutting said CPP film to dimensions matching that of the outer surface of said main body, applying said pattern layer to an inner side of said CPP film in a predetermined manner, positioning said CPP film having said pattern layer applied thereto in an injection mould, injecting a high-temperature plastic material into the mould, and allowing the injected plastic material to cool and mold, so as to form said main body of said sports protector with said CPP film bonded to said molded main body and said pattern layer enclosed between said CPP film and said main body without the risk of being rubbed away.

2. The surface structure for sports protector as claimed in claim 1, wherein said pattern layer comprises a design showing an electroplating effect.

3. The surface structure for sports protector as claimed in claim 1, wherein said pattern layer comprises a design showing a continuous laser coating effect.

4. The surface structure for sports protector as claimed in claim 1, wherein said CPP film has a thickness within the range from 0.3 mm to 1.0 mm.

5. The surface structure for sports protector as claimed in claim 1, wherein said pattern layer is applied to said CPP film by way of painting.

6. The surface structure for sports protector as claimed in claim 1, wherein said pattern layer is applied to said CPP film by way of printing.
